(19) United States
(12) Patent Application Publication
(10) Pub. No.: US 2025/0078000 A1
(43) Pub. Date: Mar. 6, 2025

(54) TRANSPORTATION SERVICE PROVISION WITH MULTI-USER MATCHING

(71) Applicant: Uber Technologies, Inc., San Francisco, CA (US)

(72) Inventors: Prateek Jain, Santa Clara, CA (US); Kevin G. Babcock, Boulder, CO (US); Samantha Wan-Jou Lin, San Francisco, CA (US); Saeed Saffari, Bothell, WA (US); Soheil Sadeghi Eshkevari, Cherry Hill, NJ (US); Rachit Kumar, San Francisco, CA (US)

(21) Appl. No.: 18/821,571

(22) Filed: Aug. 30, 2024

Related U.S. Application Data
(60) Provisional application No. 63/580,296, filed on Sep. 1, 2023.

(51) Int. Cl. G06Q 10/0631; B60W 60/00

(52) U.S. Cl. CPC G06Q 10/06316; B60W 60/0025

(57) ABSTRACT

Various examples are directed to systems and methods for operating an autonomous vehicle. A matching cycle may be executed to match respective job requests of a plurality of job requests to at least one respective vehicle of a plurality of vehicles comprising the autonomous vehicle. A set of job requests may be selected from job requests that were matched to the autonomous vehicle during the matching cycle. Verification data may be received indicating that the autonomous vehicle is suitable for the set of job requests. A first offer message may be sent to a first user device associated with a first user making a first job request of the set of job requests. A reply message responsive to the first offer message may be received from the first user device. An instruction may be sent to the autonomous vehicle to begin executing a selected job from the set of job requests. The identity of the selected job may be based at least in part on the first reply message.

### PRIORITY

This application claims the benefit of U.S. Provisional Patent Application Ser. No. 63/580,296, filed on Sep. 1, 2023, which is incorporated by reference herein in its entirety.

### BACKGROUND

An autonomous vehicle (AV) is a vehicle that is capable of sensing its environment and operating some or all of the vehicle's controls based on the sensed environment. An AV includes sensors that capture signals describing the environment surrounding the vehicle. The AV processes the captured sensor signals to comprehend the environment and automatically operates some or all of the vehicle's controls based on the resulting information.

### DRAWINGS & APPENDICES

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a diagram showing one example of an environment for managing a mixed fleet of vehicles using a service assignment system.

FIG. 2 is a workflow showing one example of a process flow that may be executed by the service assignment system of FIG. 1 to assign job requests to vehicles of the fleet of FIG. 1.

FIG. 3 is a workflow showing one example arrangement of a portion of the process flow of FIG. 2 showing the offer operation and the assign-to-vehicle operation.

FIG. 4 is a workflow showing another example arrangement of a portion of the process flow showing the offer operation and the assign-to-vehicle operation.

FIG. 5 depicts a block diagram of an example vehicle according to example aspects of the present disclosure.

FIG. 6 is a flowchart showing one example of a process flow that may be executed in the environment of FIG. 1 to assign a job request to an AV using a serial or backup offer arrangement.

FIG. 7 is a flowchart showing one example of a process flow that may be executed in the environment of FIG. 1 to assign a job request to an AV using a parallel offer arrangement.

FIG. 8 is a flowchart showing one example of a process flow that may be executed by the service assignment system of FIG. 1 to select a set of job requests for an AV.

FIG. 9 is a block diagram showing one example of a software architecture for a computing device.

FIG. 10 is a block diagram illustrating a computing device hardware architecture.

### DESCRIPTION

In an autonomous or semi-autonomous vehicle (collectively referred to as an AV), a vehicle autonomy system, sometimes referred to as an AV stack, controls one or more of braking, steering, or throttle of the vehicle. In a fully autonomous vehicle, the vehicle autonomy system assumes full control of the vehicle. In a semi-autonomous vehicle, the vehicle autonomy system assumes a portion of the vehicle control, with a human user (e.g., a vehicle operator) providing some control input. Some AVs can also operate in a manual mode, in which a human user provides all control inputs to the vehicle.

In some examples, a service assignment system receives requests for jobs from one or more users. A job is a transportation service to be performed by a vehicle. A job may include transporting a payload, such as cargo and/or one or more passengers, from a job start location to a job end location. Examples of cargo can include food, other packages, and/or the like.

The service assignment system may match received job requests from users with vehicles from a fleet of vehicles. The fleet of vehicles may include AVs. In some examples, the fleet of vehicles is a mixed fleet including both AVs and human-driven vehicles. When the service assignment system selects a vehicle for a requested job, it may instruct the vehicle to begin executing the requested job.

In some examples, the fleet of vehicles may operate with a pool of users having mixed levels of acceptance for AVs. For example, a user may be skeptical of the capabilities of an AV or otherwise uncomfortable with accepting a transportation service executed by an AV. When such a user is matched with an AV, the user may decline to have their transportation service executed by the AV.

When a user declines to have their transportation service executed by an AV, the AV does not receive a match and may be re-matched with a different user, for example at a subsequent matching cycle. This may increase the idle time of the AV, thereby reducing its utilization.

Various examples described herein address these and other challenges utilizing multi-user matching. For example, a service assignment system may receive a plurality of job requests. Each job request may be received from a user and may describe a job including a transportation service for the user, for example, as described herein. The service assignment system may execute a matching cycle to match the plurality of job requests to vehicles of a fleet of vehicles associated with the service assignment system. The matching cycle may include matching multiple users to one or more AVs. For example, an AV may be matched with multiple job requests from multiple different users.

The service assignment system may select a set of job requests for the AV. The set of job requests may be selected from job requests (and originating users) that were matched to the AV during the matching cycle. The service assignment system may communicate with a computing device associated with the AV to verify the set of job requests. The verification may include determining whether the AV is capable of performing the jobs described by the set of job requests. Optionally, verification may also include determining whether the AV is capable of performing the jobs described by the set of job requests within certain parameters such as, for example, with an acceptable walking distance for the user(s) to the job start location and from the job end location, an acceptable Estimated Time of Arrival (ETA) when the AV will arrive at the job start location, an acceptable Estimated Time of Delivery (ETD) when the AV will arrive at the job end location, and/or the like.

In some examples, the service assignment system may implement a serial or backup offer arrangement. According to a serial or backup offer arrangement, a first user from the set of users is provided with an offer message offering the AV for executing the user's requested job executed by the AV. While awaiting a reply from the first user, the remaining job requests from the set of job requests may be paused. For example, users associated with the remaining job requests may be provided with an indication that the users have not yet been matched with the vehicle. When the reply is received from the first user, if it indicates that the first user has accepted performance of the first user's requested job by the AV, then the first job may be offered to the AV. The remaining users may be rematched with different vehicles, for example, at a subsequent matching cycle.

If the reply from the first user indicates that the first user has declined performance of the first users requested job by the AV, then a second user of the set of users may be provided with an offer message offering to have the second users requested job executed by the AV. Because the second user's job request has already been verified for the AV and because the second user has been paused and is, therefore, still available, the service assignment system may offer the AV to the second user without the need to execute another matching cycle and/or verify the second user. In this way, the AV may be more quickly matched with a job to execute, thereby increasing the utilization of the AV and reducing waste.

In some examples, the service assignment system may implement a parallel offer arrangement. According to a parallel offer arrangement, all of the users associated with verified job requests from the set of job requests are provided with offer messages offering the AV to execute the users' requested jobs. The user sending the first reply message accepting the offer to be received by the service assignment system is awarded the AV. The job requests from other users are re-matched with different vehicles, for example, at a subsequent matching cycle. Because all of the user's job requests have already been verified for the AV, the service assignment system may assign the AV to whichever user replies first, for example, without the need to further verify the user's job requests. In this way, the AV may be more quickly matched with a job to execute, thereby increasing the utilization of the AV and reducing waste.

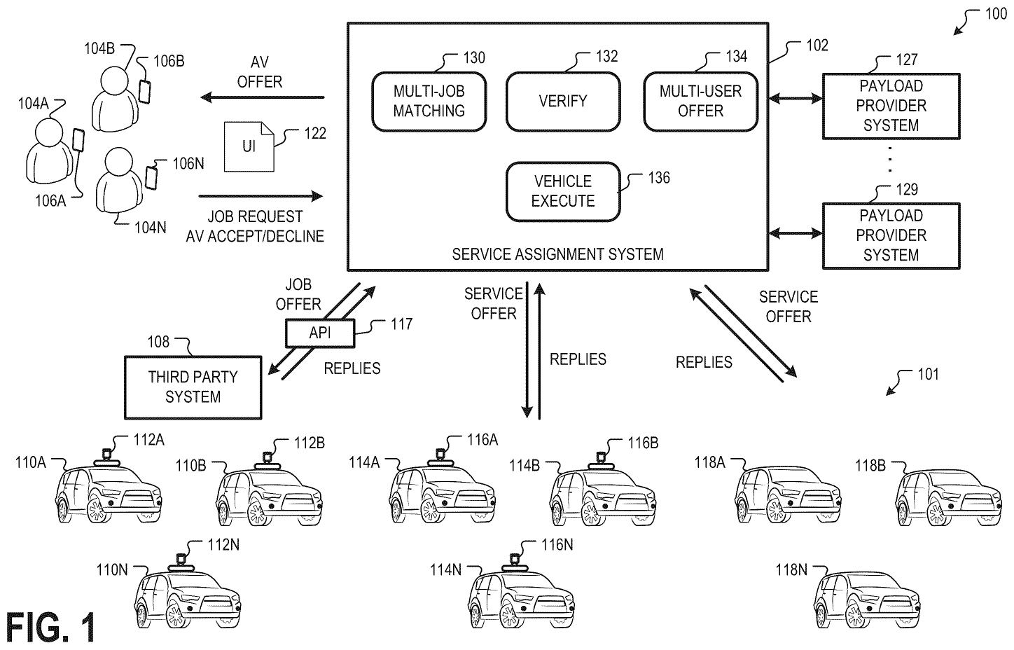

FIG. 1 is a diagram showing one example of an environment 100 for managing a mixed fleet 101 of vehicles using a service assignment system 102. The environment 100 includes the service assignment system 102, the fleet 101 of vehicles 110A, 110B, 110N, 114A, 114B, 114N, 118A, 118B, 118N, and users 104A, 104B, 104N. The fleet 101 of vehicles may be a mixed fleet including AVs and human-driven vehicles. In this example, the fleet 101 includes AVs 110A, 110B, 110N, 114A, 114B, 114N and human-driven vehicles 118A, 118B, 118N. Some or all of the vehicles 110A, 110B, 110N, 114A, 114B, 114N, 118A, 118B, 118N may be passenger vehicles, such as passenger trucks, cars, buses, or other similar vehicles. Also, some or all of the vehicles 110A, 110B, 110N, 114A, 114B, 114N, 118A, 118B, 118N may be delivery vehicles, such as vans, delivery trucks, tractor trailers, etc.

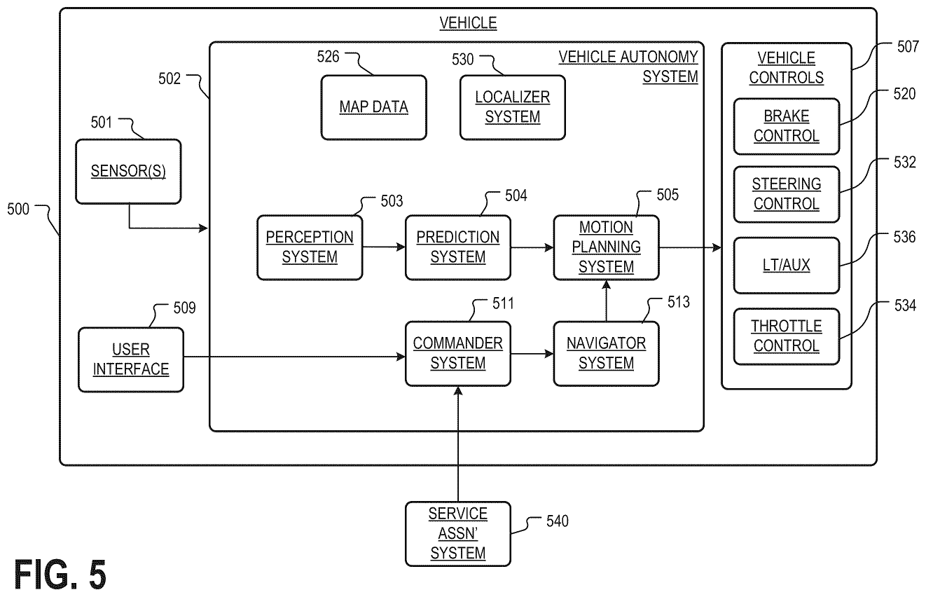

In this example, the AVs 110A, 110B, 110N, 114A, 114B, 114N include respective vehicle autonomy systems, described in more detail with respect to FIG. 5. The vehicle autonomy systems are configured to operate some or all of the controls of the AVs 110A, 110B, 110N, 114A, 114B, 114N (e.g., acceleration, braking, steering). In some examples, one or more of the AVs 110A, 110B, 110N, 114A, 114B, 114N are operable in different modes, where the vehicle autonomy system has differing levels of control over the AVs 110A, 110B, 110N, 114A, 114B, 114N. Some AVs 110A, 110B, 110N, 114A, 114B, 114N may be operable in a fully autonomous mode in which the vehicle autonomy system has responsibility for all or most of the controls of the AV 110A, 110B, 110N, 114A, 114B, 114N. Some AVs 110A, 110B, 110N, 114A, 114B, 114N are operable in a semiautonomous mode that is in addition to or instead of the fully autonomous mode. In a semiautonomous mode, the vehicle autonomy system of an AV 110A, 110B, 110N, 114A, 114B, 114N is responsible for some of the vehicle controls while a human user or driver is responsible for other vehicle controls. In some examples, one or more of the AVs 110A, 110B, 110N, 114A, 114B, 114N are operable in a manual mode in which the human user is responsible for all controls of the AVs 110A, 110B, 110N, 114A, 114B, 114N.

The AVs 110A, 110B, 110N, 114A, 114B, 114N include one or more respective remote-detection sensor sets 112A, 112B, 112N, 116A, 116B, 116N. The remote-detection sensor sets 112A, 112B, 112N, 116A, 116B, 116N include one or more remote-detection sensors that receive signals from the environment 100. The signals may be emitted by and/or reflected from objects in the environment 100, such as the ground, buildings, trees, etc. The remote-detection sensor sets 112A, 112B, 112N, 116A, 116B, 116N may include one or more active sensors, such as light imaging detection and ranging (LIDAR) sensors, radio detection and ranging (RADAR) sensors, and/or sound navigation and ranging (SONAR) sensors that emit sound or electromagnetic radiation in the form of light or radio waves to generate return signals. Information about the environment 100 is extracted from the received signals. In some examples, the remote-detection sensor sets 112A, 112B, 112N, 116A, 116B, 116N include one or more passive sensors that receive signals that originated from other sources of sound or electromagnetic radiation. The remote-detection sensor sets 112A, 112B, 112N, 116A, 116B, 116N provide remote-detection sensor data that describes the environment 100. The AVs 110A, 110B, 110N, 114A, 114B, 114N can also include other types of sensors, for example, as described in more detail with respect to FIG. 5.

In some examples, the AVs 110A, 110B, 110N, 114A, 114B, 114N are of different types. Different types of AVs may have different capabilities. For example, the different types of AVs 110A, 110B, 110N, 114A, 114B, 114N can have different vehicle autonomy systems. This can include, for example, vehicle autonomy systems made by different manufacturers or designers, vehicle autonomy systems having different software versions or revisions, etc. Also, in some examples, the different types of AVs 110A, 110B, 110N, 114A, 114B, 114N can have different remote-detection sensor sets 112A, 112B, 112N, 116A, 116B, 116N. For example, one type of AV 110A, 110B, 110N, 114A, 114B, 114N may include a LIDAR remote-detection sensor, while another type may include stereoscopic cameras and omit a LIDAR remote-detection sensor. In some examples, different types of AVs 110A, 110B, 110N, 114A, 114B, 114N can also have different mechanical particulars. For example, one type of vehicle may have all-wheel drive, while another type may have front-wheel drive, etc.

In the example of FIG. 1, the AVs 110A, 110B, 110N are managed by a third-party system 108. The third-party system 108 may be implemented by an entity that manages or otherwise operates the AVs 110A, 110B, 110N. For example, jobs assigned to the AVs 110A, 110B, 110N may be communicated from the service assignment system 102 to the third-party system 108. The third-party system 108 may communicate the jobs to the respective AVs 110A, 110B, 110N. Replies accepting or declining a job assigned to an AV 110A, 110B, 110N may be sent from the third-party system 108 to the service assignment system 102.

In some examples, the third-party system 108 may accept and/or decline a job on behalf of the AVs 110A, 110B, 110N (e.g., without communicating the job to the AVs 110A, 110B, 110N for acceptance). Although one third-party system 108 and associated AVs 110A, 110B, 110N are shown in FIG. 1, it will be appreciated that other examples of the environment 100 may include multiple third-party systems and associated AVs.

In some examples, communication between the service assignment system 102 and one or more third-party systems 108 is performed via an application programming interface (API) such as API 117. For example, job assigned by the service assignment system 102 to one or more of the AVs 110A, 110B, 110N using one or more calls by the service assignment system 102 and/or by the third-party system 108 to the API 117. Similarly, replies from the third-party system 108 to the service assignment system 102 may involve one or more calls to the API 117 by the third-party system 108 or the service assignment system 102. For example, the third-party system 108 may reply to a job assigned to one of its managed AVs 110A, 110B, 110N by accepting or declining the job. Also, although a single API 117 is shown in FIG. 1, it will be appreciated that some arrangements may include multiple APIs for managing communications between the third-party system 108 and the service assignment system 102. For example, different APIs may be used for different communication tasks.

In some examples, the service assignment system 102 may communicate directly with AVs 114A, 114B, 114N (e.g., not through a third-party system 108). For example, the service assignment system 102 may provide job offers and receive replies directly to AVs 114A, 114B, 114N. The AVs 114A, 114B, 114N with which the service assignment system 102 communicates directly may be operated and/or managed by a third-party and/or by the entity implementing the service assignment system 102.

In the example of FIG. 1, the service assignment system 102 also communicates with human-driven vehicles 118A, 118B, 118N, for example, to assign jobs and receive replies accepting or declining the assigned jobs. The service assignment system 102 may communicate with the vehicles 118A, 118B, 118N themselves (e.g., through an infotainment system or other suitable computing system of the vehicle) and/or with one or more of the human drivers of the vehicles 118A, 118B, 118N (e.g., via a user computing device or devices of the human drivers). It will be appreciated that FIG. 1 shows just one example of a mixed fleet and that different mixed fleets may have different numbers and proportions of AVs and human-driven vehicles.

The example environment 100 describes a mixed fleet 101 including AVs 110A, 110B, 110N managed by the third-party system 108, AVs, AVs managed by the service assignment system 102 and human-driven vehicles 118A, 118B, 118N. It will be appreciated, however, that in various examples, the environment 100 includes more or fewer different types of vehicles. For example, in some arrangements, the service assignment system 102 may assign jobs to multiple third-party fleets of AVs via multiple third-party systems (e.g., and multiple APIs or API instances). In other examples, some or all of the vehicle types shown in the environment 100 may be omitted. For example, the service assignment system 102 may be configured to offer service assignments only to AVs or only to AVs managed by third-party systems, or permutations thereof.

The service assignment system 102 is programmed to receive job requests from the users 104A, 104B, 104N and assign requested jobs to vehicles selected from the fleet 101 of vehicles as described herein. The service assignment system 102 can be or include one or more servers or other suitable computing devices. The service assignment system 102 is configured to receive job requests from one or more users 104A, 104B, 104N. The users 104A, 104B, 104N make job requests with user computing devices 106A, 106B, 106N. The user computing devices 106A, 106B, 106N can be or include any suitable computing device such as, for example, tablet computers, mobile telephone devices, laptop computers, desktop computers, etc. In some examples, the user computing devices 106A, 106B, 106N execute an application associated with a job implemented with the service assignment system 102. The users 104A, 104B, 104N launch the application on the respective user computing devices 106A, 106B, 106N and utilize functionality of the application to make job requests.

In some examples, the service assignment system 102 provides a user interface 122 to the users 104A, 104B, 104N via the respective user computing devices 106A, 106B, 106N. The UI 122 may provide functionality allowing the users to make job requests. For example, the UI 122 may include fields in which a user 104A, 104B, 104N can provide job request properties such as, for example, a job start location, a job end location, a description of the desired payload (e.g., size and weight of payload, number of passengers, etc.), and/or the like.

In some examples, a user 104A, 104B, 104N may request a job that involves the delivery of a product, where the product is all or part of the payload of the job. For example, a user 104A, 104B, 104N may request delivery of a meal from a restaurant or other provider, a delivery of a purchase from a store or other provider. In some examples, the service assignment system 102 is in communication with one or more payload provider systems 127, 129. Payload provider systems 127, 129 are associated with restaurants, stores, or other entities that provide payloads for jobs, for example, where the payloads are delivered to the job end location.

In some examples, the UI 122 includes information about payload that can be provided by a payload provider system 127, 129. Consider an example in which a job is to deliver food prepared by a payload provider system 127, 129. The UI 122 may include fields allowing the user 104A, 104B to select the payload provider system 127, 129 and/or items from the menu of the payload provider system 127, 129 for delivery. The properties of the job request, then, can include the identified payload. When a vehicle accepts the requested job, the service assignment system 102 may provide an instruction to the selected payload provider system 127, 129 requesting preparation of the payload and providing information about the vehicle that will pick up the payload for delivery.

The service assignment system 102 is programmed to receive and process job requests from users 104A, 104B, 104N. Upon receiving a plurality of job request, the service assignment system 102 may match some or all of the job requests to one or more vehicles of the fleet 101. This may result in matches between job requests received from the users 104A, 104B, 104N and vehicles from the fleet 101.

The matches for a given job request may be with a vehicle or vehicles that are suitable, or potentially suitable, for executing the requested job. The service assignment system 102 may match a vehicle or vehicle to a job request based on, for example, the positions of the various vehicles in the fleet 101, the availability of the various vehicles in the fleet 101, jobs currently being executed by the various vehicles of the fleet 101, properties of the job request, user preferences, a capacity of the vehicle, and/or the like. In some examples, the service assignment system 102 may match a requested job to one or more vehicles of the fleet 101 that have the capacity to carry a payload indicated by the job request and are near the job start location, or will be near the job start location, for example, after completing the vehicle's current job.

From the matches, the service assignment system 102 may select a vehicle or vehicles to which the requested job will be offered. The service assignment system 102 may select the vehicle or vehicles based on any suitable criterion or criteria such as, for example, vehicle locations, vehicle cost to execute the requested job, a prior acceptance rate of the vehicle and/or of vehicles of the same time, etc. In some examples, the service assignment system 102 selects a vehicle or vehicles to offer a job using a route for the job, which may be generated by the service assignment system 102, by the third-party system 108, and/or by any other suitable component of the environment 100.

In some examples, matches between job requests (and corresponding users) and vehicles of the fleet 101 may be verified before the job requests are offered to the vehicles. Verifying a match between a job request and a vehicle may include sending job request data describing the job request to a computing system associated with the vehicle. The computing system is, for example, a vehicle autonomy system of an AV, a third-party system 108, and/or the like.

The computing system for the vehicle may reply with verification data. The verification data may indicate that the vehicle is suitable or unsuitable for the job described by the job request. In some examples, the verification data directly indicates that the vehicle is either suitable or unsuitable for the job. In other examples, the verification data includes parameters of how the vehicle could perform the job such as, for example, a pickup location, a drop-off location, and ETA, an ETD, and/or the like. The service assignment system may compare the parameters of how the vehicle would perform the job to one or more service rules. If the parameters are in compliance with service roles, then the vehicle may be verified for the job.

Service rules may include, for example, a maximum ETAs, a maximum ETD, a maximum walking distance to a pickup location from the job start location, a maximum walking distance from a drop-off location to the job and location, and/or the like. If a match between a job request and a vehicle is verified, the service assignment system 102 may offer the requested job to the vehicle.

In some examples, the service assignment system 102 is programmed to also offer an AV to a user 104A, 104B, 104N whose job request has been matched to that AV. The offer to the user may occur before the requested job is assigned to the AV. In this way, the user may have an opportunity to decline the match if, for example, the user would prefer that the user's transportation service be performed by a human driven vehicle, or the user prefers a different match for another reason. In other examples, the service assignment system 102 is programmed to offer AVs and human driven vehicles to users whose job requests have been matched to the respective vehicles before assigning the job to those vehicles.

In some examples, the service assignment system 102 is programmed to match more than one job request (and, therefore, more than one user 104A, 104B, 104N) to a single AV, such as one of AVs 110A, 110B, 110N 114A, 114B, 114N of the fleet 101. The service assignment system 102 may receive job requests from multiple users 104A, 104B, 104N. The service assignment system 102 (e.g., a multi-job matching routine 130 executed thereby) may match more than one of the job requests to the single AV. For example, the single AV is positioned near job start locations of more than one user 104A, 104B, 104N, currently executing a job with a job end point near the job start locations of more than one user 104A, 104B, 104N, and/or otherwise well-suited to execute jobs from multiple job offers.

From the multiple matches, the multi-job matching routine 130 may select a set of job requests for the single AV. The set of job requests selected for the AV may include job requests matched to the AV with a match quality exceeding a threshold value, a predetermined number of job requests constituting the best matches to the AV, and/or the like.

The service assignment system 102 (e.g. a verify routine 132 executed thereby) may verify each job request of the set of job requests for the AV. If the computing device associated with the AV indicates that the AV is not verified and/or not suitable for a job request from the set of job requests, then that job request or job requests may be removed from the set of job requests.

Upon selecting an AV 110A, 110B, 110N, the service assignment system 102 (e.g., a multi-user offer routine 134 thereof) may provide an offer to one or more of the users associated with the set of job requests. The offers may be provided to the users 104A, 104B, 104N via the UI 122.

In some examples, the multi-user offer routine 134 provides multiple offers in parallel. For example, the multi-offer routine 134 may provide an offer to each user associated with a job request of the set of job requests for the AV. The offer may invite the users to accept the offer to receive their requested job via the AV. In some examples, the AV is assigned to the user whose message accepting the offer is received first. For example, the service assignment system 102 (e.g. the vehicle execute routine 136) may assign the AV to the job of the first user to respond. The other users associated with other job requests from the set of job requests may have their job requests re-matched by the service assignment system 102 to another vehicle of the fleet 101. Because all of the job requests of the set of job requests were previously verified, the service assignment system 102 may award the AV to the first user to respond without re-verifying, thus increasing the rate of match for the AV and accordingly increasing its utilization.

Also, in some examples, the multi-user offer routine 134 provides offers to the users associated with the set of job requests in serial. For example, the multi-user offer routine 134 may provide a first offer to a first user associated with a first job request from the set of job requests for the AV. The other job requests from the set of job request may be held as backups. The first user may be the user associated with the job request having a highest quality match with the AV. Other users associated with other job requests from the set of job requests may be paused. That is, for example, the other users may not be matched with other vehicles from the fleet 101. If the job requests of the other users were matched with other vehicles from the fleet 101 other than the AV, then the other matched vehicles from the fleet 101 may be assigned to other job requests not from the set of job requests.

If the first user accepts the first offer, then the vehicle execute routine 136 may assign the AV to the first user, for example, by assigning the first user's job request to the AV. If the first user declines the first offer, then the multi-user offer routine 134 may send a second offer to a second user associated with a second job request of the set of job requests. The first user may be re-matched with another vehicle of the fleet 101, for example, at a subsequent matching cycle. If the second user accepts the offer, then the AV may be assigned to the second user, for example, by offering the second user's job request to the AV. The remaining users may be re-matched to other vehicles from the fleet 101, for example, at a subsequent matching cycle. This process may continue until a user has accepted the AV for the user's job request, or another termination event has occurred. The other termination event may include, for example, a predetermined number of users declining the AV, a predetermined amount of time elapsing since the previous matching cycle, and/or the like. Because all of the job requests of the set of job requests were previously verified, each successive backup job request may be quickly offered to the AV, without the need to re-verify.

In some examples, one or more of the users 104A, 104B, 104N indicates a durable opt-in. The durable opt-in may indicate that a user 104B, 104B, 104N consents to having jobs provided by an AV. A user may indicate a durable opt-in to AV service, for example, by accepting one or a predetermined other number of AV-executed jobs, by indicating a durable opt-in via the UI 122, or in any other suitable manner.

When a user 104B, 104B, 104N who has made a durable AV opt-in is matched with an AV, that user may be awarded the AV. For example, if the set of job requests for an AV includes a job request from a user who has made a durable AV opt-in, that user may be awarded the AV. If the set of job requests for an AV includes job requests from multiple users who have made durable AV op-ins, the user with a durable opt in and the job request having the highest quality match to the AV may be awarded the AV.

In some examples, the service assignment system 102 is programmed to determine sets of multiple matched job requests for one or more of the AVs of the fleet 101. Each individual AV that is matched to a set of multiple job requests may be handled, for example, as described herein. Accordingly, in some examples, a user 104A, 104B, 104N serves as a backup user for more than one AV. For example, if a user's job request is part of the set of matched job requests for multiple AVs but is not the highest quality match for any of the AVs, the user may be a backup for each of the multiple AVs. If the user is offered one of the AVs (for example, when another user declines an offer for the AV), the user may be removed from the set of matched job requests for other AVs.

The various routines 130, 132, 134, 136 of the service assignment system may comprise various hardware and/or software for executing the operations described herein.

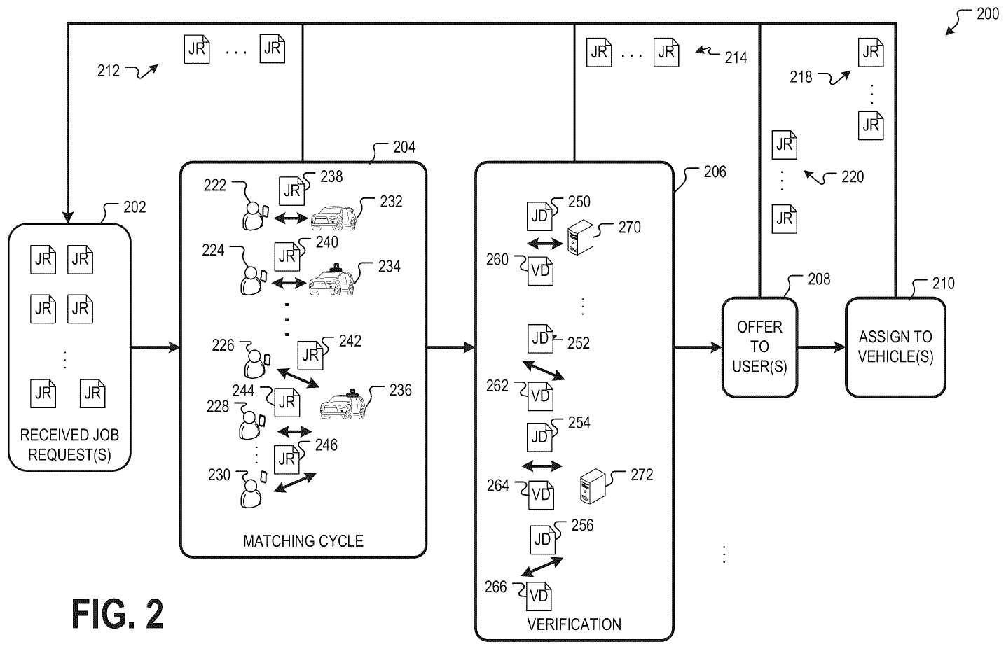

FIG. 2 is a workflow showing one example of a process flow 200 that may be executed by the service assignment system 102 of FIG. 1 to assign job requests 202 to vehicles of the fleet 101. The process flow 200 begins with a pool of received job requests 202. The pool of received job requests 202 includes job requests that have been received from users that are awaiting a match with a vehicle from the fleet 101. The job requests may be received via user computing devices (106A, 106B, 106N) and via the UI 122 as described herein.

At operation 204, the service assignment system 102 (e.g. the multi-job matching routine 130 thereof) may execute a matching cycle. The matching cycle may involve matching job requests from the job requests received at operation 202 to vehicles of the fleet 101. The matching cycle may be performed using any suitable matching algorithm. Example matching algorithms that can be used include, for example, crossing network algorithms, and/or the like. In some examples, the matching algorithm returns a number of matches between job offers in vehicles and a match score for each match. The match score for a match between a vehicle and a job request may indicate a quality of the match. For example, if one match is assigned a more favorable match score it may indicate that the vehicle of the first match is better suited to the job of the first match than the vehicle of the second match is to the job of the second match. For example, the more favorably matched vehicle may be closer to the relevant job start location, scheduled to be closer to the relevant job start location, able to execute the respective job with a lower ETA, ETD, walking distance to the pickup location, walking distance to the job ended location, and/or the like. Various different matching to be used such as, for example, Bipartite Graph matching.

FIG. 2 also shows an example result of a matching cycle. In this example, a job request 238 from a user 222 is matched to a human-driven vehicle 232. A job request 240 from a user 224 is matched to an AV 234. An AV 236 is matched to a set of job requests 242, 244, 246 received from multiple users 226, 228, 230. In some examples, not all of the job requests of the pool of job requests 202 are matched by the matching cycle at operation 204. For example, the fleet 101 may not include a suitable vehicle that is available to perform some of the job requests of the pool of job requests 202. Job requests 212 that are not matched at the matching cycle of operation 204 are returned to the pool of job requests 202 to be matched at a subsequent matching cycle. It will be appreciated that the number of example matches shown here is for illustrative purposes only. In various examples, additional vehicles are matched with additional job requests from additional users. Also, although the set of job requests for the AV 236 includes three job requests 242, 244, 246, AVs may be matched with more or fewer job requests.

At operation 206, the service assignment system 102 (e.g., the verify routine 132 thereof) may verify matches made during the matching cycle at operation 204. This may include, for example, sending job request data to one or more computing devices associated with the vehicles matched to the respective job requests. The computing devices may return respective verification data. The verification data, in some examples, indicates whether the vehicle is suitable for a job request. For example, the AV or its associated computing device may determine that the capabilities of the AV are insufficient to perform the requested job. If this occurs, the computing device will return verification data indicating that the AV is not suitable for the job. In some examples, the verification data includes parameters under which the vehicle could perform the requested job. This may include, for example, an ETA, an ETD, a pickup location, a drop-off location, a route that the vehicle will use to execute the job, and/or the like. In some examples, the verification data also includes an operational domain or other capability data describing capabilities of the AV.

When the verification data includes parameters under which the vehicle could perform the requested job, the service assignment system 102 may analyze the verification data to determine whether the vehicle is suitable to perform the requested job. The vehicle may be suitable to perform the requested job, for example, if the parameters indicated by the verification data meat one or more service rules. In some examples, the verification performed at operation 206 is performed with respect to matches of AVs only. That is, matches to human-driven vehicles may not be verified before a matched job is offered to the human-driven vehicle.

FIG. 2 also shows an example verification arrangement. In the example of FIG. 2, job request data 250 corresponding to job request 240 is provided to a computing device 270 associated with the AV 234. The computing device 270 may be, for example, a vehicle autonomy system of the AV or a third-party system 108. The computing device 270 may provide verification data 260. Job request data 252 corresponding to the job request 242 is provided to a computing device 272 associated with the AV 236. Because a set of multiple job requests 242, 244, 246 were matched to the AV 236, job request data 254 and job request data 256 are also provided to the computing device 272.

The computing device 272 may provide verification data 262, 264, 266 to the service assignment system 102. If the verification data 262, 264, 266 indicates that the AV 236 is not suitable for performing any of the job requests 242, 244, 246, then the job request or job requests for which the AV 236 is unsuitable is removed from the set of job requests 242, 244, 246. Job requests 214 that are not successfully verified at operation 206 may be returned to the pool of job requests 202 for matching at a subsequent matching cycle at operation 204.

At operation 208, the service assignment system 102 (e.g. the multi-user offer routine 134 thereof) may send offers to users associated with job requests that have been matched to vehicles (and verified at operation 206). In some examples, the operation 208 is executed only for job requests that have been matched to AVs and may be omitted for job requests that have been matched to human-driven vehicles. Job requests 220 associated with users who decline offers at operation 208 may be returned to the pool of job requests 202 for matching at a subsequent matching cycle at operation 204. For users who accept offers at operation 208, the service assignment system 102 may assign those users' job requests to the matched vehicles at operation 210. This may include, for example, sending an assignment of the requested job to the matched vehicle, for example, and receiving an indication of whether the vehicle accepts or declines the assigned job. If the assigned vehicle rejects a job, the corresponding job requests 218 are returned to the pool of job requests 202 to be matched to a vehicle at a subsequent matching cycle.

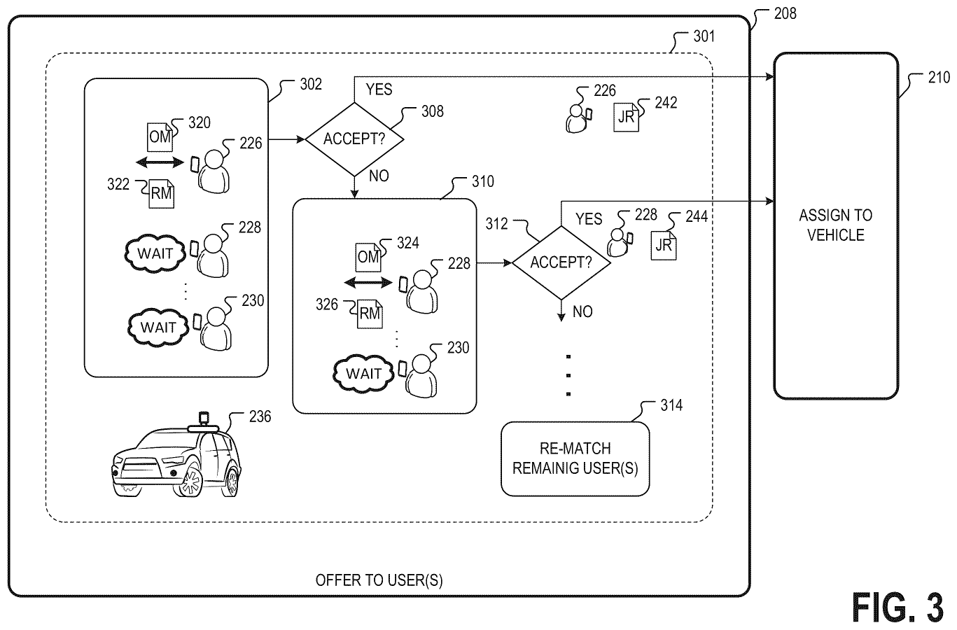

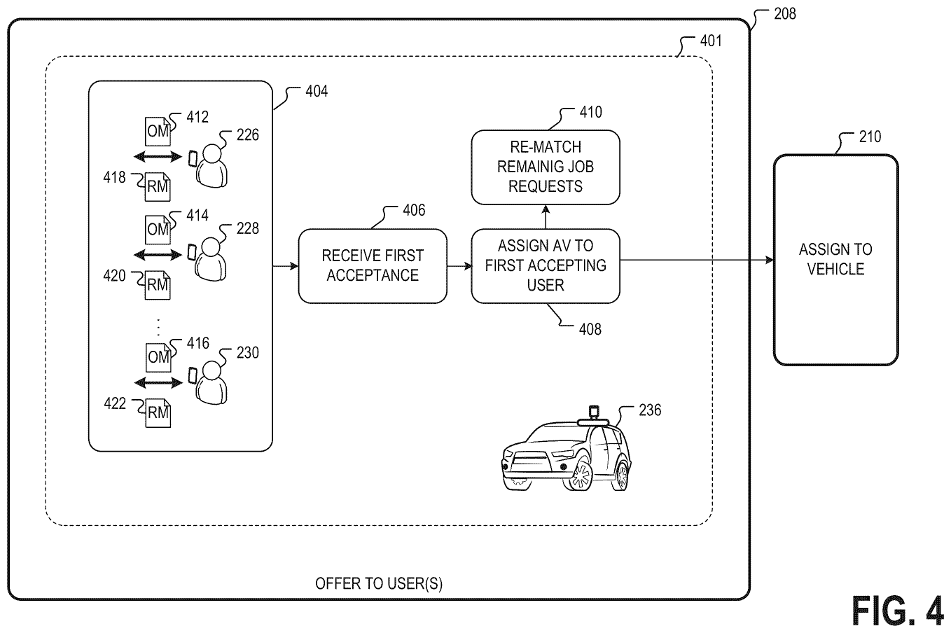

FIG. 3 is a workflow showing one example arrangement of a portion of the process flow 200 showing the offer operation 208 and the assign-to-vehicle operation 210. FIG. 3 shows a portion 301 of the offer operation 208 corresponding to the AV 236 and implementing a serial or backup job request arrangement for the AV 236. It will be appreciated that other portions of the offer operation 208 (e.g., not shown in FIG. 3) may deal with matches to other vehicles, including other AVs. Matches to other AVs may be performed in a manner similar to that of the portion 301, or in a different manner (e.g., as described herein with respect to FIG. 4).

Recall that, in the example of FIG. 2, the set of job requests assigned to the AV 236 included the job request 242 made by the user 226, the job request 244 made by the user 228, and the job request 246 made by the user 230. In this example, all of the job requests 242, 244, 246 were verified. At operation 302, the service assignment system 102 may send an offer message 320 to the user 226. The offer message 320 may offer the AV 236 to the user 226 to execute the job indicated by the job request 242. The user 226 may optionally send a reply message 322. The reply message 322 may indicate that the user 226 has accepted the AV 236 or declined the AV 236. While the offer message 320 is sent to the user 226 and before the reply message 322 is received, the users 228, 230 and their respective job requests 244, 246 may be paused. For example, the job requests 244, 246 of the users 228, 230 may not be matched to or assigned to other vehicles during this time.

At operation 308, the service assignment system 102 may determine if the user 226 accepted the offer of the AV 236. The user 226 may accept the offer of the AV 236, for example, by providing a reply message 322 indicating the acceptance. If the user 226 accepts the offer of the AV 236, then the user 226 and associated job request 244 are assigned to the AV 236 at operation 210.

The user 226 may decline the offer, for example, by sending a reply message 322 indicating that the offer was declined and/or by failing to send any reply message 322 within a predetermined time period. If, at operation 308, the service assignment system 102 determines that the user 226 has declined the offer, then, at operation 310, the service assignment system 102 may send an offer message 324 to the next user 228 offering the AV 236 to execute the job indicated by the job request 244. The user 228 may (optionally) send a reply message 326 indicating acceptance or nonacceptance of the offer. The remaining user 230 or users having job requests in the set of job requests for the AV 236 may continue to wait at operation 310. At operation 312, the service assignment system 102 may determine whether the user 228 has accepted the offer indicated by the offer message 324. If the user 228 has accepted, then the AV 236 may be assigned to the job request 244 made by the user 228 at operation 210, for example, as described herein.

The portion 301 may continue, for example, until a job from the set of job requests is assigned to the AV 236. In some examples, the portion 301 concludes before a job request is assigned to the AV 236, for example, if more than a predetermined number of users decline an offer of the AV 236, if more than a threshold time has passed since the matching cycle operation that created the set of job requests for the AV 236, and/or for other reasons. Job requests from the set of job requests that are not assigned to the AV at portion 301 may be rematched to other vehicles of the fleet 101 at operation 314. For example, job requests that are not matched to the AV 236 may be returned to the pool of job requests 202 for matching at a subsequent matching cycle. If the portion 301 concludes a job being assigned to the AV 236, the AV 236 may be rematched with one or more other job requests, for example, at a subsequent matching cycle.

FIG. 4 is a workflow showing another example arrangement of a portion of the process flow 200 showing the offer operation 208 and the assign-to-vehicle operation 210. FIG. 4 shows a portion 401 of the offer operation 208 corresponding to the AV 236 and implementing a parallel job request arrangement for the AV 236.

At operation 404, the service assignment system 102 may send offer messages 412, 414, 416 to each of the respective users 226, 228, 230 corresponding to the set of job offers. The users 226, 228, 230 may provide reply messages 418, 420, 422. Reply messages 418, 420, 422 may accept the offer of the AV 236 or decline the offer of the AV 236. At operation 406, the service assignment system 102 may receive the first reply message 418, 420, 422 accepting the offer of the AV 236. The first reply message 418, 420, 422 accepting the offer of the AV 236 may be the first message 418, 420, 422 received in time that indicates acceptance. At operation 408, the service assignment system 102 may assign the AV 236 to the job offer corresponding to the first reply message 418, 420, 422 accepting the offer of the AV 236. At operation 410, remaining job requests from the set of job requests may be rematched with other vehicles from the fleet 101, for example, in a subsequent matching cycle.

FIG. 5 depicts a block diagram of an example vehicle 500 according to example aspects of the present disclosure. The vehicle 500 shows one example arrangement of the AVs 110A, 110B, 110N, 114A, 114B, 114N of FIG. 1. The vehicle 500 includes one or more sensors 501, a vehicle autonomy system 502, and one or more vehicle controls 507. The vehicle 500 is an AV, as described herein. The example vehicle 500 shows just one example arrangement of an AV. In some examples, AVs of different types can have different arrangements.

The vehicle autonomy system 502 includes a commander system 511, a navigator system 513, a perception system 503, a prediction system 504, a motion planning system 505, and a localizer system 530 that cooperate to perceive the surrounding environment of the vehicle 500 and determine a motion plan for controlling the motion of the vehicle 500 accordingly.

The vehicle autonomy system 502 is engaged to control the vehicle 500 or to assist in controlling the vehicle 500. In particular, the vehicle autonomy system 502 receives sensor data from the one or more sensors 501, attempts to comprehend the environment surrounding the vehicle 500 by performing various processing techniques on data collected by the sensors 501, and generates an appropriate route through the environment. The vehicle autonomy system 502 sends commands to control the one or more vehicle controls 507 to operate the vehicle 500 according to the route.

Various portions of the vehicle autonomy system 502 receive sensor data from the one or more sensors 501. For example, the sensors 501 may include remote-detection sensors as well as motion sensors such as an inertial measurement unit (IMU), one or more encoders, or one or more odometers. The sensor data includes information that describes the location of objects within the surrounding environment of the vehicle 500, information that describes the motion of the vehicle 500, etc.

The sensors 501 may also include one or more remote-detection sensors or sensor systems, such as a LIDAR system, a RADAR system, one or more cameras, etc. As one example, a LIDAR system of the one or more sensors 501 generates sensor data (e.g., remote-detection sensor data) that includes the location (e.g., in three-dimensional space relative to the LIDAR system) of a number of points that correspond to objects that have reflected a ranging laser. For example, the LIDAR system measures distances by measuring the Time of Flight (TOF) that it takes a short laser pulse to travel from the sensor to an object and back, calculating the distance from the known speed of light.

As another example, a RADAR system of the one or more sensors 501 generates sensor data (e.g., remote-detection sensor data) that includes the location (e.g., in three-dimensional space relative to the RADAR system) of a number of points that correspond to objects that have reflected ranging radio waves. For example, radio waves (e.g., pulsed or continuous) transmitted by the RADAR system reflect off an object and return to a receiver of the RADAR system, giving information about the object's location and speed. Thus, a RADAR system provides useful information about the current speed of an object.

As yet another example, one or more cameras of the one or more sensors 501 may generate sensor data (e.g., remote-detection sensor data) including still or moving images. Various processing techniques (e.g., range imaging techniques such as structure from motion, structured light, stereo triangulation, and/or other techniques) can be performed to identify the location (e.g., in three-dimensional space relative to the one or more cameras) of a number of points that correspond to objects that are depicted in an image or images captured by the one or more cameras. Other sensor systems can identify the location of points that correspond to objects as well.

As another example, the one or more sensors 501 can include a positioning system. The positioning system determines a current position of the vehicle 500. The positioning system can be any device or circuitry for analyzing the position of the vehicle 500. For example, the positioning system can determine a position by using one or more of inertial sensors, a satellite positioning system such as the Global Positioning System (GPS), a positioning system based on IP address, triangulation and/or proximity to network access points or other network components (e.g., cellular towers, Wi-Fi access points), and/or other suitable techniques. The position of the vehicle 500 can be used by various systems of the vehicle autonomy system 502.

Thus, the one or more sensors 501 are used to collect sensor data that includes information that describes the location (e.g., in three-dimensional space relative to the vehicle 500) of points that correspond to objects within the surrounding environment of the vehicle 500. In some implementations, the sensors 501 can be positioned at different locations on the vehicle 500. As an example, in some implementations, one or more cameras and/or LIDAR sensors can be located in a pod or other structure that is mounted on a roof of the vehicle 500, while one or more RADAR sensors can be located in or behind the front and/or rear bumper(s) or body panel(s) of the vehicle 500. As another example, one or more cameras can be located at the front or rear bumper(s) of the vehicle 500. Other locations can be used as well.

The localizer system 530 receives some or all of the sensor data from the sensors 501 and generates vehicle poses for the vehicle 500. A vehicle pose describes a position and attitude of the vehicle 500. The vehicle pose (or portions thereof) can be used by various other components of the vehicle autonomy system 502 including, for example, the perception system 503, the prediction system 504, the motion planning system 505, and the navigator system 513.

The position of the vehicle 500 is a point in a three-dimensional space. In some examples, the position is described by values for a set of Cartesian coordinates, although any other suitable coordinate system may be used. The attitude of the vehicle 500 generally describes the way in which the vehicle 500 is oriented at its position. In some examples, attitude is described by a yaw about the vertical axis, a pitch about a first horizontal axis, and a roll about a second horizontal axis. In some examples, the localizer system 530 generates vehicle poses periodically (e.g., every second, every half second). The localizer system 530 appends time stamps to vehicle poses, where the time stamp for a pose indicates the point in time that is described by the pose. The localizer system 530 generates vehicle poses by comparing sensor data (e.g., remote-detection sensor data) to map data 526 describing the surrounding environment of the vehicle 500.

In some examples, the localizer system 530 includes one or more pose estimators and a pose filter. Pose estimators generate pose estimates by comparing remote-detection sensor data (e.g., LIDAR, RADAR) to map data. The pose filter receives pose estimates from the one or more pose estimators as well as other sensor data such as, for example, motion sensor data from an IMU, encoder, or odometer. In some examples, the pose filter executes a Kalman filter or machine learning algorithm to combine pose estimates from the one or more pose estimators with motion sensor data to generate vehicle poses. In some examples, pose estimators generate pose estimates at a frequency less than the frequency at which the localizer system 530 generates vehicle poses. Accordingly, the pose filter generates some vehicle poses by extrapolating from a previous pose estimate utilizing motion sensor data.

Vehicle poses and/or vehicle positions generated by the localizer system 530 are provided to various other components of the vehicle autonomy system 502. For example, the commander system 511 may utilize a vehicle position to determine whether to respond to a call from a service assignment system 540.

The commander system 511 determines a set of one or more target locations that are used for routing the vehicle 500. The target locations are determined based on user input received via a user interface 509 of the vehicle 500. The user interface 509 may include and/or use any suitable input/output device or devices. In some examples, the commander system 511 determines the one or more target locations considering data received from the service assignment system 540. The service assignment system 540 is programmed to provide instructions to multiple vehicles, for example, as part of a fleet of vehicles for moving passengers and/or cargo. Data from the service assignment system 540 can be provided via a wireless network, for example.

The navigator system 513 receives one or more target locations from the commander system 511 and map data 526. The map data 526, for example, provides detailed information about the surrounding environment of the vehicle 500. The map data 526 provides information regarding identity and location of different roadways and roadway elements. A roadway is a place where the vehicle 500 can drive and may include, for example, a road, a street, a highway, a lane, a parking lot, or a driveway. Routing graph data is a type of map data 526.

From the one or more target locations and the map data 526, the navigator system 513 generates route data describing a route for the vehicle 500 to take to arrive at the one or more target locations. In some implementations, the navigator system 513 determines route data using one or more path-planning algorithms based on costs for graph elements/corresponding roadway elements, as described herein. For example, a cost for a route can indicate a time of travel, risk of danger, or other factors associated with adhering to a particular proposed route. Route data describing a route is provided to the motion planning system 505, which commands the vehicle controls 507 to implement the route or route extension, as described herein. The navigator system 513 can generate routes as described herein using a general-purpose routing graph and routing graph modification data. Also, in examples where route data is received from the service assignment system 540, the route data can also be provided to the motion planning system 505.

The perception system 503 detects objects in the surrounding environment of the vehicle 500 based on sensor 501 data, the map data 526, and/or vehicle poses provided by the localizer system 530. For example, the map data 526 used by the perception system 503 describes roadways and segments thereof and may also describe buildings or other items or objects (e.g., lampposts, crosswalks, curbing); location and directions of traffic lanes or lane segments (e.g., the location and direction of a parking lane, a turning lane, a bicycle lane, or other lanes within a particular roadway); traffic control data (e.g., the location and instructions of signage, traffic lights, or other traffic control devices); and/or any other map data that provides information that assists the vehicle autonomy system 502 in comprehending and perceiving its surrounding environment and its relationship thereto.

In some examples, the perception system 503 determines state data for one or more of the objects in the surrounding environment of the vehicle 500. State data describes a current state of an object (also referred to as features of the object). The state data for each object describes, for example, an estimate of the object's current location (also referred to as position); current speed (also referred to as velocity); current acceleration; current heading; current orientation; size/shape/footprint (e.g., as represented by a bounding shape such as a bounding polygon or polyhedron); type/class (e.g., vehicle, pedestrian, bicycle, or other); yaw rate; distance from the vehicle 500; minimum path to interaction with the vehicle 500; minimum time duration to interaction with the vehicle 500; and/or other state information.

In some implementations, the perception system 503 determines state data for each object over a number of iterations. In particular, the perception system 503 updates the state data for each object at each iteration. Thus, the perception system 503 detects and tracks objects, such as other vehicles, that are proximate to the vehicle 500 over time.

The prediction system 504 is configured to predict one or more future positions for an object or objects in the environment surrounding the vehicle 500 (e.g., an object or objects detected by the perception system 503). The prediction system 504 generates prediction data associated with one or more of the objects detected by the perception system 503. In some examples, the prediction system 504 generates prediction data describing each of the respective objects detected by the perception system 503.

Prediction data for an object is indicative of one or more predicted future locations of the object. For example, the prediction system 504 may predict where the object will be located within the next 5 seconds, 30 seconds, 500 seconds, etc. Prediction data for an object may indicate a predicted trajectory (e.g., predicted path) for the object within the surrounding environment of the vehicle 500. For example, the predicted trajectory (e.g., path) can indicate a path along which the respective object is predicted to travel over time (and/or the speed at which the object is predicted to travel along the predicted path). The prediction system 504 generates prediction data for an object, for example, based on state data generated by the perception system 503. In some examples, the prediction system 504 also considers one or more vehicle poses generated by the localizer system 530 and/or map data 526.

In some examples, the prediction system 504 uses state data indicative of an object type or classification to predict a trajectory for the object. As an example, the prediction system 504 can use state data provided by the perception system 503 to determine that a particular object (e.g., an object classified as a vehicle) approaching an intersection and maneuvering into a left-turn lane intends to turn left. In such a situation, the prediction system 504 predicts a trajectory (e.g., path) corresponding to a left turn for the vehicle such that the vehicle turns left at the intersection. Similarly, the prediction system 504 determines predicted trajectories for other objects, such as bicycles, pedestrians, parked vehicles, etc. The prediction system 504 provides the predicted trajectories associated with the object(s) to the motion planning system 505.

In some implementations, the prediction system 504 is a goal-oriented prediction system 504 that generates one or more potential goals, selects one or more of the most likely potential goals, and develops one or more trajectories by which the object can achieve the one or more selected goals. For example, the prediction system 504 can include a scenario generation system that generates and/or scores the one or more goals for an object, and a scenario development system that determines the one or more trajectories by which the object can achieve the goals. In some implementations, the prediction system 504 can include a machine-learned goal-scoring model, a machine-learned trajectory development model, and/or other machine-learned models.

The motion planning system 505 commands the vehicle controls 507 based at least in part on the predicted trajectories associated with the objects within the surrounding environment of the vehicle 500, the state data for the objects provided by the perception system 503, vehicle poses provided by the localizer system 530, the map data 526, and route or route extension data provided by the navigator system 513. Stated differently, given information about the current locations of objects and/or predicted trajectories of objects within the surrounding environment of the vehicle 500, the motion planning system 505 determines control commands for the vehicle 500 that best navigate the vehicle 500 along the route or route extension relative to the objects at such locations and their predicted trajectories on acceptable roadways.

In some implementations, the motion planning system 505 can also evaluate one or more cost functions and/or one or more reward functions for each of one or more candidate control commands or sets of control commands for the vehicle 500. Thus, given information about the current locations and/or predicted future locations/trajectories of objects, the motion planning system 505 can determine a total cost (e.g., a sum of the cost(s) and/or reward(s) provided by the cost function(s) and/or reward function [s]) of adhering to a particular candidate control command or set of control commands. The motion planning system 505 can select or determine a control command or set of control commands for the vehicle 500 based at least in part on the cost function(s) and the reward function(s). For example, the motion plan that minimizes the total cost can be selected or otherwise determined.

In some implementations, the motion planning system 505 can be configured to iteratively update the route or route extension for the vehicle 500 as new sensor data is obtained from the one or more sensors 501. For example, as new sensor data is obtained from the one or more sensors 501, the sensor data can be analyzed by the perception system 503, the prediction system 504, and the motion planning system 505 to determine the motion plan.

The motion planning system 505 can provide control commands to the one or more vehicle controls 507. For example, the one or more vehicle controls 507 can include throttle systems, brake systems, steering systems, and other control systems, each of which can include various vehicle controls (e.g., actuators or other devices that control gas flow, steering, and braking) to control the motion of the vehicle 500. The various vehicle controls 507 can include one or more controllers, control devices, motors, and/or processors.

The vehicle controls 507 include a brake control module 520. The brake control module 520 is configured to receive a braking command and bring about a response by applying (or not applying) the vehicle brakes. In some examples, the brake control module 520 includes a primary system and a secondary system. The primary system receives braking commands and, in response, brakes the vehicle 500. The secondary system may be configured to determine a failure of the primary system to brake the vehicle 500 in response to receiving the braking command.

A steering control system 532 is configured to receive a steering command and bring about a response in the steering mechanism of the vehicle 500. The steering command is provided to a steering system to provide a steering input to steer the vehicle 500.

A lighting/auxiliary control module 536 receives a lighting or auxiliary command. In response, the lighting/auxiliary control module 536 controls a lighting and/or auxiliary system of the vehicle 500. Controlling a lighting system may include, for example, turning on, turning off, or otherwise modulating headlights, parking lights, running lights, etc. Controlling an auxiliary system may include, for example, modulating windshield wipers, a defroster, etc.

A throttle control system 534 is configured to receive a throttle command and bring about a response in the engine speed or other throttle mechanism of the vehicle. For example, the throttle control system 534 can instruct an engine and/or engine controller, or other propulsion system component, to control the engine or other propulsion system of the vehicle 500 to accelerate, decelerate, or remain at its current speed.

Each of the perception system 503, the prediction system 504, the motion planning system 505, the commander system 511, the navigator system 513, and the localizer system 530 can be included in or otherwise be a part of the vehicle autonomy system 502 configured to control the vehicle 500 based at least in part on data obtained from the one or more sensors 501. For example, data obtained by the one or more sensors 501 can be analyzed by each of the perception system 503, the prediction system 504, and the motion planning system 505 in a consecutive fashion in order to control the vehicle 500. While FIG. 5 depicts elements suitable for use in a vehicle autonomy system according to example aspects of the present disclosure, one of ordinary skill in the art will recognize that other vehicle autonomy systems can be configured to control an AV based on sensor data.

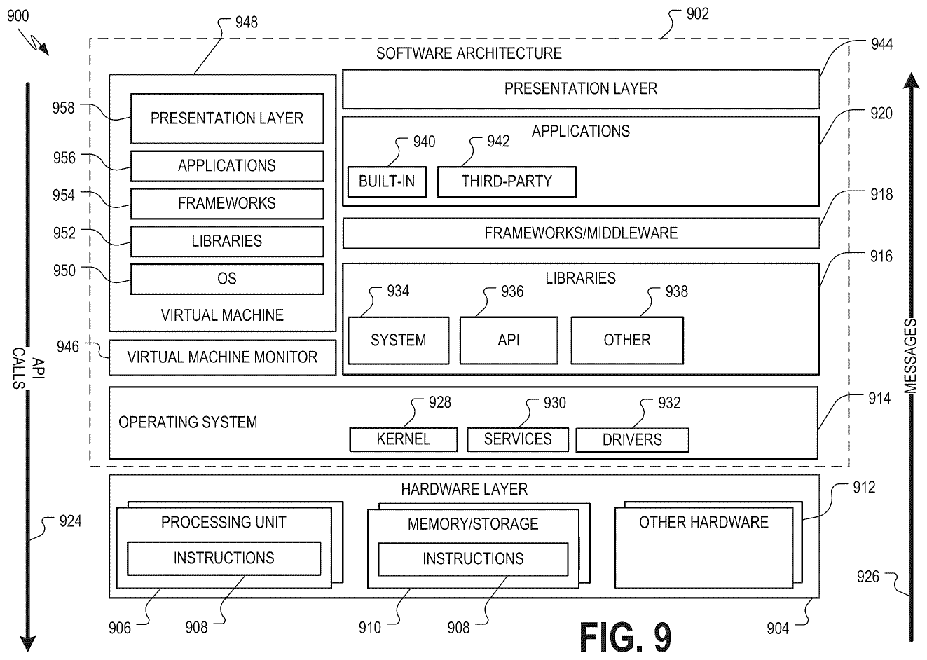

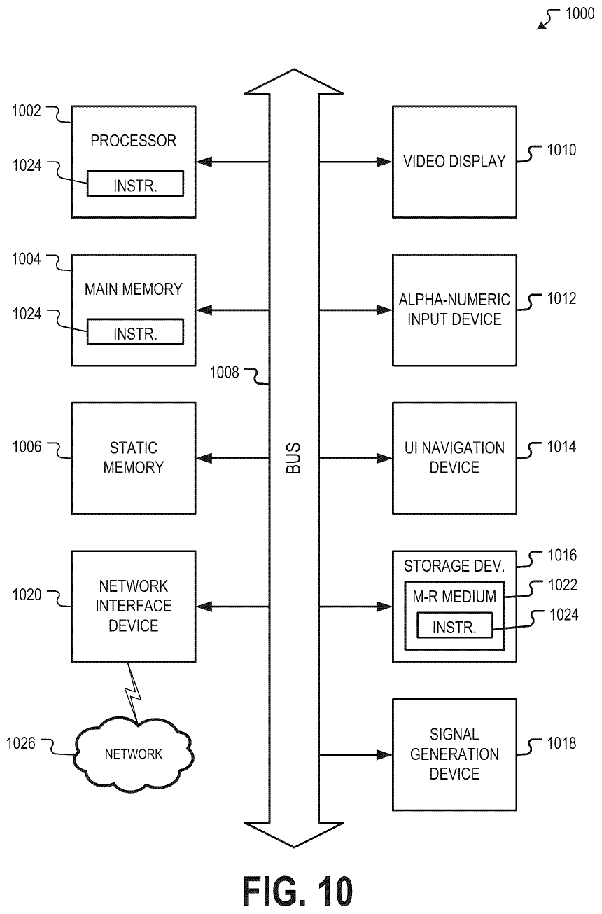

The vehicle autonomy system 502 includes one or more computing devices, which may implement all or parts of the perception system 503, the prediction system 504, the motion planning system 505, and/or the localizer system 530. Descriptions of hardware and software configurations for computing devices to implement the vehicle autonomy system 502 and/or the service assignment system 102 of FIG. 1 are provided herein with reference to FIGS. 9 and 10.

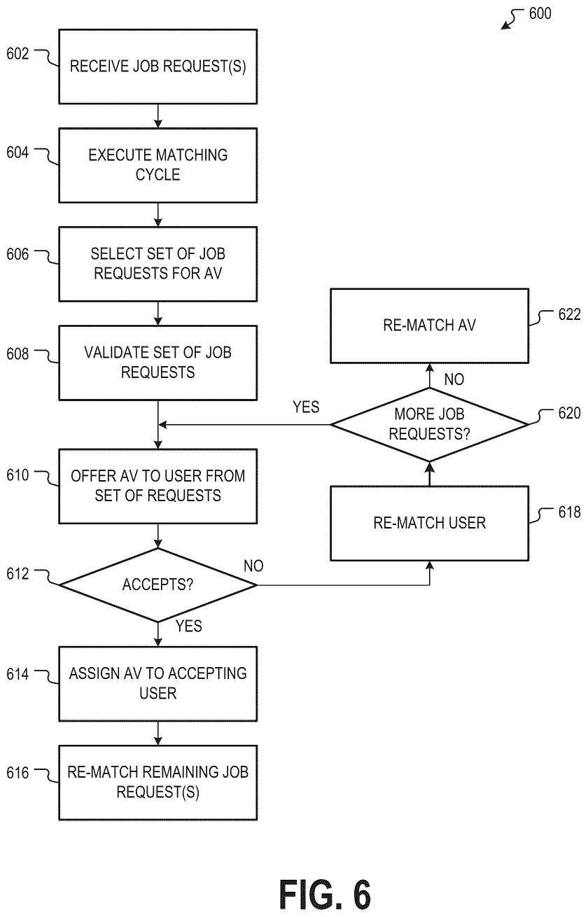

FIG. 6 is a flowchart showing one example of a process flow 600 that may be executed in the environment 100 of FIG. 1 to assign a job request to an AV using a serial or backup offer arrangement. At operation 602, the service assignment system 102 may receive a plurality of job requests from a plurality of users. Each job request may describe a requested job, for example, as described herein. At operation 604, the service assignment system 102 executes a matching cycle to match job requests from the plurality of job requests to one or more vehicles of the vehicle fleet 101.

Matches generated at operation 604 may be used to assign job requests from the received job requests to the various vehicles of the fleet 101. Operations 606, 608, 610, 612, 614, 616, 618, 620, and 622 describe selecting a job request and assigning the job request to a particular AV. It will be appreciated, that these operations (or other operations) may be executed by the service assignment system 102 to use other matches generated by the matching cycle at operation 604 to assign other job requests to other vehicles in the fleet 101. In some examples, the service assignment system 102 executes additional instances of the operations 606, 608, 610, 612, 614, 616, 618, 620, and/or 622 to use matches generated by the matching cycle of operation 604 to assign job requests to other AVs of the fleet 101. Also, in some examples, the service assignment system 102 executes instances of operations 706, 708, 710, 712, 714, and 716 of the process flow 700 to use matches generated by the matching cycle of operation 604 to assign job requests to other AVs of the fleet 101.

At operation 606, the service assignment system 102 may select a set of job requests for an AV. The set of job requests may include job requests that were matched to the AV at the matching cycle executed at operation 604. In some examples, a predetermined number of job requests having the highest match scores with the AV is selected. In another example, job requests having match scores with the AV above a threshold may be selected.

At operation 608, the service assignment system 102 may validate the job requests from the set of job requests, for example, as described herein. Any job requests selected for the set of job requests at operation 606 that cannot be validated at operation 608 may be removed from the set of job requests.

At operation 610, the service assignment system 102 may offer the AV to a user corresponding to a job request from the set of job requests. The selected user may be associated with the job request having the highest match score with the AV. In other examples, the selected user may be determined in other ways. In some examples, a job request is randomly selected from the set of job requests and the message sent to the corresponding user. This may occur, for example, when multiple job requests have the same match score with the AV.

At operation 612, the service assignment system 102 may determine if the user offered the AV at operation 610 accepts the offer. If the user accepts the offer, then the service assignment system 102 assigns the AV to the accepting user at operation 614. This may include, for example, sending an assignment of the selected job request to the AV and/or to a computing device associated with the AV. If the AV accepts the assignment, this may indicate that the AV is to begin executing the job corresponding to the selected job request. At operation 616, the service assignment system 102 may rematch job requests (if any) remaining from the set of job requests for the AV to other vehicles from the fleet 101, for example, at a subsequent matching cycle.

If, at operation 612, the user offered the AV at operation 610 declines the offer and/or fails to provide a reply message indicating acceptance of the offer within a threshold time, the service assignment system 102 may re-match that user's job request to a different vehicle from the fleet 101 at operation 618. This may include, for example, returning the job request to the pool of job requests.

At operation 620, the service assignment system 102 may determine if there are any remaining job requests from the set of job requests. If there are more job requests, the service assignment system 102 may return to operation 610 and offer the AV to a next user associated with a next job request from the set of job requests for the AV. The next job request may be, for example, the job request having the next most favorable match score, or may be randomly selected, for example, as described herein. If there are no remaining job requests from the set of job requests at operation 620, then the service assignment system 102 may rematch the AV to one or more additional job requests at operation 622.

In some examples, the operations 606, 608, 610, 612, 614, 616, 618, 620, and/or 622 are executed in parallel for multiple different AVs of the fleet 101. Accordingly, in some examples, the service assignment system 102 is programmed to assign a single job request to the set of job requests for more than one AV. If a job request that is part of the set of job requests for more than one AV is assigned to one of the AVs, it may be removed from the set of job requests for the other AV. Accordingly, determining whether there are more job requests at operation 620 may include determining if all of the users originally assigned to the set of job requests for the AV have either been offered the AV at operation 610 or assigned to another AV.

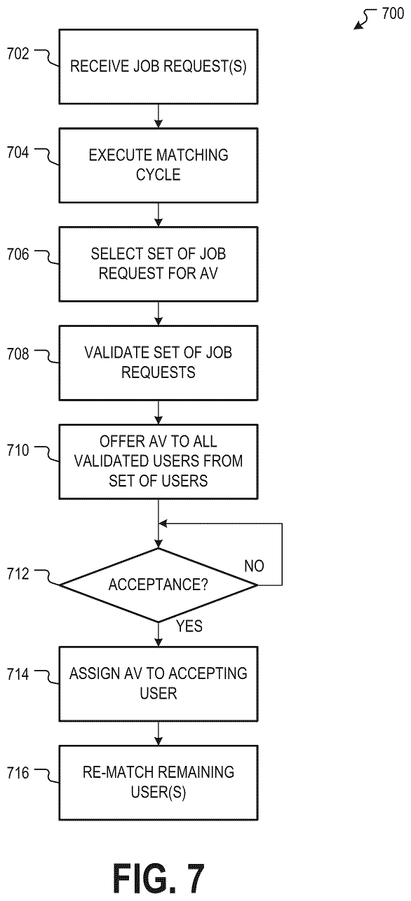

FIG. 7 is a flowchart showing one example of a process flow 700 that may be executed in the environment 100 of FIG. 1 to assign a job request to an AV using a parallel offer arrangement. At operation 702, the service assignment system 102 may receive a plurality of job requests from a plurality of users. Each job request may describe a requested job, for example, as described herein. At operation 704, the service assignment system 102 executes a matching cycle to match job requests from the plurality of job requests to one or more vehicles of the vehicle fleet 101.

Matches generated at operation 704 may be used to assign job requests from the received job requests to the various vehicles of the fleet 101. Operations 706, 708, 710, 712, 714, and 716 describe selecting a job request and assigning the job request to a particular AV. It will be appreciated, that these operations (or other operations) may be executed by the service assignment system 102 to use other matches generated by the matching cycle at operation 704 to assign other job requests to other vehicles in the fleet 101. In some examples, the service assignment system 102 executes additional instances of the operations 706, 708, 710, 712, 714, and 716 to use matches generated by the matching cycle of operation 704 to assign job requests to other AVs of the fleet 101. Also, in some examples, the service assignment system 102 executes instances of operations 606, 608, 610, 612, 614, 616, 618, 620, and/or 622 of the process flow 600 to use matches generated by the matching cycle of operation 704 to assign job requests to other AVs of the fleet 101.

At operation 706, the service assignment system 102 may select a set of job requests for an AV. The set of job requests may include job requests that were matched to the AV at the matching cycle executed at operation 704. In some examples, a predetermined number of job requests having the highest match scores with the AV are selected. In another example, job requests having match scores with the AV above a threshold may be selected.

At operation 708, the service assignment system 102 may validate the job requests from the set of job requests, for example, as described herein. Any job requests selected for the set of job requests at operation 706 that cannot be validated at operation 708 may be removed from the set of job requests.

At operation 710, the service assignment system 102 may offer the AV to all users associated with job requests from the set of job requests. This may include, for example, sending an offer message to all of the users associated with job requests from the set of job requests. At operation 712, the service assignment system 102 determines if it has received an acceptance from any of the users. If it is not yet received an acceptance, it returns to operation 712 to wait for an acceptance. When an acceptance is received at operation 712, the service assignment system, at operation 714, assigns the AV to the user who sent the first acceptance received at operation 712. At operation 716, the service assignment system 102 re-matches job requests from the set of job requests that were not assigned to the AV, for example, at a subsequent matching cycle. In some examples, if none of the users provide an acceptance within a predetermined time period, all of the set of job requests and the AV are rematched at a subsequent matching cycle.

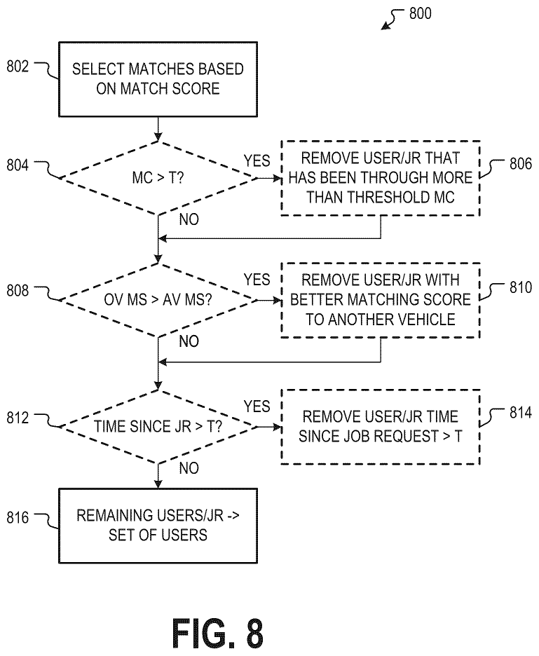

FIG. 8 is a flowchart showing one example of a process flow 800 that may be executed by the service assignment system 102 of FIG. 1 to select a set of job requests for an AV. The process flow 800 shows one example way of executing the operation 606 of the process flow 600 or the operation 706 of the process flow 700.

At operation 802, the service assignment system 102 selects job requests for the AV from matches generated for the AV by a matching cycle. The matches may be selected based on the matches respective match scores. In some examples, the N job requests having the highest match scores are selected, where N is a predetermined number. Also, in some examples, all job requests having match scores with the AV greater than a threshold are selected. In some examples, a single job offer is part of a group of selected job offers for more than one AV, for example, as described herein.

Operations 804, 806, 808, 810, 812, and 814 are optional operations that may be performed, for example, to remove job requests from the job requests selected at operation 802. For example, these operations may filter from the set of job requests for an AV job requests that have already been backup offers for other AVs, or would otherwise undesirably compromise the customer experience of the users making the job requests.

For example, at optional operation 804, the service assignment system 102 may determine if any of the job requests selected at operation 802 have already been through more than a threshold number of matching cycles without having been assigned to a vehicle. A job request may go through a matching cycle if it is considered for a matching cycle. A job requests considered in a matching cycle may be matched to a vehicle and/or may not be matched to a vehicle and returned to the pool of job requests. At optional operation 806, job requests selected at operation 802 that have already been through more than a threshold number of matching cycles may be removed from the set of job requests for the AV selected at operation 802.

At optional operation 808, the service assignment system 102 may determine if any remaining job requests selected at operation 802 for the AV have a match score with another vehicle that is higher than a threshold. At optional operation 810, job requests selected at operation 802 that have a match score with another vehicle higher than the threshold may be removed from the set of job requests for the AV.

At optional operation 812, the service assignment system 102 may determine if any job requests selected at operation 802 were received more than a threshold time in the past. If any job requests selected at operation 802 were received more than a threshold time ago the service assignment system 102 may remove those job requests from the set of selected job requests for the AV at operation 814. For example, these job requests may be assigned to other vehicles with which they were matched during the previous match cycle, making it less likely that these job requests are subjected to an additional matching cycle and associated additional delays. Job requests remaining from the job requests selected at operation 802 may be returned as the set of job requests for the AV at operation 816.

In view of the disclosure above, various examples are set forth below. It should be noted that one or more features of an example, taken in isolation or combination, should be considered within the disclosure of this application.

Example 1 is a system for operating an autonomous vehicle, comprising: at least one processor programmed to perform operations comprising: receiving a plurality of job requests; executing a matching cycle to match respective job requests of the plurality of job requests to at least one respective vehicle of a plurality of vehicles, the plurality of vehicles comprising the autonomous vehicle; selecting a set of job requests from the plurality of job requests that were matched to the autonomous vehicle during the matching cycle, the set of job requests comprising a first job request from a first user and a second job request from a second user; sending job request data describing the set of job requests to an autonomous vehicle computing device associated with the autonomous vehicle; receiving verification data from the autonomous vehicle computing device, the verification data indicating that the autonomous vehicle is suitable for the set of job requests; sending, to a first user device associated with the first user, a first offer message describing a first offer for the autonomous vehicle to execute a first job indicated by the first job request; receiving, from the first user device, a first reply message responsive to the first offer; and sending an instruction for the autonomous vehicle to begin executing a selected job from the set of job requests, an identity of the selected job being based at least in part on the first reply message.

In Example 2, the subject matter of Example 1 optionally includes the first reply message indicating that the first user has rejected the first offer, the operations further comprising: after receiving the first reply message, sending, to a second user computing device associated with the second user, a second offer for the autonomous vehicle to execute a second job indicated by the second job request; and receiving, from the second user computing device, a reply message responsive to the second offer, the reply message responsive to the second offer indicating that the second user has accepted the second offer, and the selected job being the second job.

In Example 3, the subject matter of any one or more of Examples 1-2

optionally includes the first job being the selected job, the operations further comprising, after receiving the first reply message, matching the second job request to a second vehicle different than the autonomous vehicle.

In Example 4, the subject matter of Example 3 optionally includes the first reply message indicating that the first user has accepted the first offer and the selected job being the first job, the operations further comprising, after receiving the first reply message, executing a second matching cycle to match the second job request to the second vehicle.

In Example 5, the subject matter of any one or more of Examples 1-4 optionally includes the selecting of the set of job requests comprising: determining a portion of the plurality of job requests that were matched to the autonomous vehicle by the matching cycle; accessing vehicle match score data for each of the portion of the plurality of job requests; and based on the vehicle match score data, selecting at least one of the plurality of job requests for including in the set of job requests.

In Example 6, the subject matter of Example 5 optionally includes the operations further comprising: determining that a third job request of the portion of the plurality of job requests has been considered by more than a threshold number of matching cycles; and omitting the third job request from the set of job requests.

In Example 7, the subject matter of any one or more of Examples 5-6 optionally includes the operations further comprising: determining that more than a threshold amount of time has elapsed since receiving a third job request of the plurality of job requests; and omitting the third job request from the set of job requests.

In Example 8, the subject matter of any one or more of Examples 5-7 optionally includes the set of job requests comprising a predetermined number of job requests from the portion of the plurality of job requests that were matched to the autonomous vehicle.

In Example 9, the subject matter of any one or more of Examples 5-8 optionally includes the operations further comprising: determining that a third job request of the portion of the plurality of job requests has a match score for a second vehicle of the plurality of vehicles that is more favorable than a match score between the third job request and the autonomous vehicle; and omitting the third job request from the set of job requests.

In Example 10, the subject matter of any one or more of Examples 1-9 optionally includes the operations further comprising, selecting a second set of job requests from the plurality of job requests that were matched to a second autonomous vehicle, the second set of job requests comprising the second job request and a third job request from a third user; sending job request data describing the second set of job requests to a second autonomous vehicle computing device associated with the second autonomous vehicle; receiving second verification data from the second autonomous vehicle computing device, the second verification data indicating that the second autonomous vehicle is suitable for the second set of job requests; sending an offer message to a third user device associated with the third user, the offer message describing an offer for the second autonomous vehicle to execute a third job indicated by the third job request; receiving, from the third user device, a reply message declining the offer for the second autonomous vehicle to execute the third job; and after receiving the reply message from the third user device, sending, to a second user computing device associated with the second user, an offer message describing an offer for the second autonomous vehicle to execute a second job indicated by the second job request.

In Example 11, the subject matter of any one or more of Examples 1-

10 optionally includes the operations further comprising, before receiving the first reply message, sending to a second user computing device associated with the second user, a second offer for the autonomous vehicle to execute a second job indicated by the second job request, the selected job being the first job.

In Example 12, the subject matter of Example 11 optionally includes the operations further comprising receiving, from the second user computing device, a second reply message responsive to the second offer, the first reply message being received before the second reply message.

In Example 13, the subject matter of any one or more of Examples 1-12 optionally includes the operations further comprising after selecting the set of job requests, determining that durable AV opt-in data has been received from the first user, the selected job being the first job.

Example 14 is a method for operating an autonomous vehicle, the method comprising: receiving a plurality of job requests; executing a matching cycle to match respective job requests of the plurality of job requests to at least one respective vehicle of a plurality of vehicles, the plurality of vehicles comprising the autonomous vehicle; selecting a set of job requests from the plurality of job requests that were matched to the autonomous vehicle during the matching cycle, the set of job requests comprising a first job request from a first user and a second job request from a second user; sending job request data describing the set of job requests to an autonomous vehicle computing device associated with the autonomous vehicle; receiving verification data from the autonomous vehicle computing device, the verification data indicating that the autonomous vehicle is suitable for the set of job requests; sending, to a first user device associated with the first user, a first offer message describing a first offer for the autonomous vehicle to execute a first job indicated by the first job request; receiving, from the first user device, a first reply message responsive to the first offer; and sending an instruction for the autonomous vehicle to begin executing a selected job from the set of job requests, an identity of the selected job being based at least in part on the first reply message.

In Example 15, the subject matter of Example 14 optionally includes the first reply message indicating that the first user has rejected the first offer, the method further comprising: after receiving the first reply message, sending, to a second user computing device associated with the second user, a second offer for the autonomous vehicle to execute a second job indicated by the second job request; and receiving, from the second user computing device, a reply message responsive to the second offer, the reply message responsive to the second offer indicating that the second user has accepted the second offer, and the selected job being the second job.

In Example 16, the subject matter of any one or more of Examples 14-15 optionally includes the first job being the selected job, the method further comprising, after receiving the first reply message, matching the second job request to a second vehicle different than the autonomous vehicle.

In Example 17, the subject matter of Example 16 optionally includes the first reply message indicating that the first user has accepted the first offer and the selected job being the first job, the method further comprising, after receiving the first reply message, executing a second matching cycle to match the second job request to the second vehicle.

In Example 18, the subject matter of Example 17 optionally includes the selecting of the set of job requests comprising: determining a portion of the plurality of job requests that were matched to the autonomous vehicle by the matching cycle; accessing vehicle match score data for each of the portion of the plurality of job requests; and based on the vehicle match score data, selecting at least one of the plurality of job requests for including in the set of job requests.

In Example 19, the subject matter of any one or more of Examples 14-18 optionally includes before receiving the first reply message, sending to a second user computing device associated with the second user, a second offer for the autonomous vehicle to execute a second job indicated by the second job request, the selected job being the first job.

Example 20 is a non-transitory machine-readable medium comprising instructions thereon that, when executed by at least one processor, because the at least one processor to perform operations comprising: receiving a plurality of job requests; executing a matching cycle to match respective job requests of the plurality of job requests to at least one respective vehicle of a plurality of vehicles, the plurality of vehicles comprising an autonomous vehicle; selecting a set of job requests from the plurality of job requests that were matched to the autonomous vehicle during the matching cycle, the set of job requests comprising a first job request from a first user and a second job request from a second user; sending job request data describing the set of job requests to an autonomous vehicle computing device associated with the autonomous vehicle; receiving verification data from the autonomous vehicle computing device, the verification data indicating that the autonomous vehicle is suitable for the set of job requests; sending, to a first user device associated with the first user, a first offer message describing a first offer for the autonomous vehicle to execute a first job indicated by the first job request; receiving, from the first user device, a first reply message responsive to the first offer; and sending an instruction for the autonomous vehicle to begin executing a selected job from the set of job requests, an identity of the selected job being based at least in part on the first reply message.

FIG. 9 is a block diagram 900 showing one example of a software architecture 902 for a computing device. The software architecture 902 may be used in conjunction with various hardware architectures, for example, as described herein. FIG. 9 is merely a non-limiting example of a software architecture 902, and many other architectures may be implemented to facilitate the functionality described herein. A representative hardware layer 904 is illustrated and can represent, for example, any of the above-referenced computing devices. In some examples, the hardware layer 904 is implemented according to a hardware architecture, such as the hardware architecture 1000 of FIG. 10 and/or the software architecture 902 of FIG. 9.

The representative hardware layer 904 comprises one or more processing units 906 having associated executable instructions 908. The executable instructions 908 represent the executable instructions of the software architecture 902, including implementation of the methods, modules, components, and so forth of FIGS. 1-8. The hardware layer 904 also includes memory and/or storage modules 910, which also have the executable instructions 908. The hardware layer 904 may also comprise other hardware 912, which represents any other hardware of the hardware layer 904, such as the other hardware illustrated as part of the hardware architecture 1000.

In the example architecture of FIG. 9, the software architecture 902 may be conceptualized as a stack of layers where each layer provides particular functionality. For example, the software architecture 902 may include layers such as an operating system 914, libraries 916, middleware layer 918, applications 920, and a presentation layer 944. Operationally, the applications 920 and/or other components within the layers may invoke application programming interface (API) calls 924 through the software stack and receive a response, returned values, and so forth illustrated as messages 926 in response to the API calls 924. The layers illustrated are representative in nature, and not all software architectures have all layers. For example, some mobile or special-purpose operating systems may not provide a middleware layer 918, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. In some examples, the services 930 include an interrupt service. The interrupt service may detect the receipt of a hardware or software interrupt and, in response, cause the software architecture 902 to pause its current processing and execute an interrupt service routine (ISR) when an interrupt is received. The ISR may generate an alert.

The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 916 may provide a common infrastructure that may be used by the applications 920 and/or other components and/or layers. The libraries 916 typically provide functionality that allows other software modules to perform tasks in an easier fashion than by interfacing directly with the underlying operating system 914 functionality (e.g., kernel 928, services 930, and/or drivers 932). The libraries 916 may include system libraries 934 (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The middleware layer 918 (also sometimes referred to as frameworks) may provide a higher-level common infrastructure that may be used by the applications 920 and/or other software components/modules. For example, the middleware layer 918 may provide various graphical user interface (GUI) functions, high-level resource management, high-level location services, and so forth. The middleware layer 918 may provide a broad spectrum of other APIs that may be used by the applications 920 and/or other software components/modules, some of which may be specific to a particular operating system or platform.

The applications 920 include built-in applications 940 and/or third-party applications 942. Examples of representative built-in applications 940 may include, but are not limited to, a contacts application, a browser application, a book reader application, a location application, a media application, a messaging application, and/or a game application. The third-party applications 942 may include any of the built-in applications 940 as well as a broad assortment of other applications. In a specific example, the third-party application 942 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 942 may invoke the API calls 924 provided by the mobile operating system such as the operating system 914 to facilitate functionality described herein.

The applications 920 may use built-in operating system functions (e.g., kernel 928, services 930, and/or drivers 932), libraries (e.g., system libraries 934, API libraries 936, and other libraries 938), or middleware layer 918 to create user interfaces to interact with users of the system. Alternatively, or additionally, in some systems, interactions with a user may occur through a presentation layer, such as the presentation layer 944. In these systems, the application/module “logic” can be separated from the aspects of the application/module that interact with a user.

Some software architectures use virtual machines. For example, systems described herein may be executed using one or more virtual machines executed at one or more server computing machines. In the example of FIG. 9, this is illustrated by a virtual machine 948. A virtual machine creates a software environment where applications/modules can execute as if they were executing on a hardware computing device. The virtual machine 948 is hosted by a host operating system (e.g., the operating system 914) and typically, although not always, has a virtual machine monitor 946, which manages the operation of the virtual machine 948 as well as the interface with the host operating system (e.g., the operating system 914). A software architecture executes within the virtual machine 948, such as an operating system 950, libraries 952, frameworks/middleware 954, applications 956, and/or a presentation layer 958. These layers of software architecture executing within the virtual machine 948 can be the same as corresponding layers previously described or may be different.

FIG. 10 is a block diagram illustrating a hardware architecture 1000 of an example computing device, within which a set or sequence of instructions can be executed to cause a machine to perform examples of any one of the methodologies discussed herein. The hardware architecture 1000 describes a computing device for executing the vehicle autonomy system, described herein.

The hardware architecture 1000 may operate as a standalone device or may be connected (e.g., networked) to other machines. In a networked deployment, the hardware architecture 1000 may operate in the capacity of either a server or a client machine in server-client network environments, or it may act as a peer machine in peer-to-peer (or distributed) network environments. The hardware architecture 1000 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example hardware architecture 1000 includes a processor unit 1002 comprising at least one processor (e.g., a central processing unit (CPU), a graphics processing unit (GPU), or both, processor cores, compute nodes). The hardware architecture 1000 may further comprise a main memory 1004 and a static memory 1006, which communicate with each other via a link 1008 (e.g., a bus). The hardware architecture 1000 can further include a video display unit 1010, an input device 1012 (e.g., a keyboard), and a UI navigation device 1014 (e.g., a mouse). In some examples, the video display unit 1010, input device 1012, and UI navigation device 1014 are incorporated into a touchscreen display. The hardware architecture 1000 may additionally include a storage device 1016 (e.g., a drive unit), a signal generation device 1018 (e.g., a speaker), a network interface device 1020, and one or more sensors (not shown), such as a Global Positioning System (GPS) sensor, compass, accelerometer, or other sensor.

In some examples, the processor unit 1002 or another suitable hardware component may support a hardware interrupt. In response to a hardware interrupt, the processor unit 1002 may pause its processing and execute an ISR, for example, as described herein.

The storage device 1016 includes a machine-readable medium 1022 on which is stored one or more sets of data structures and instructions 1024 (e.g., software) embodying or used by any one or more of the methodologies or functions described herein. The instructions 1024 can also reside, completely or at least partially, within the main memory 1004, within the static memory 1006, and/or within the processor unit 1002 during execution thereof by the hardware architecture 1000, with the main memory 1004, the static memory 1006, and the processor unit 1002 also constituting machine-readable media.

### Executable Instructions and Machine-Storage Medium

The various memories (i.e., main memory 1004, static memory 1006, and/or memory of the processor unit(s) 1002) and/or the storage device 1016 may store one or more sets of instructions and data structures (e.g., the instructions 1024) embodying or used by any one or more of the methodologies or functions described herein. These instructions, when executed by the processor unit(s) 1002, cause various operations to implement the disclosed examples.

As used herein, the terms “machine-storage medium,” “device-storage medium,” and “computer-storage medium” (referred to collectively as “machine-storage medium”) mean the same thing and may be used interchangeably. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Signal Medium

The term “signal medium” or “transmission medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium” and “device-readable medium” mean the same thing and may be used interchangeably in this disclosure. The terms are defined to include both non-transitory machine-storage media and signal media. Thus, the terms include both storage devices/media and carrier waves/modulated data signals.

The instructions 1024 can further be transmitted or received over a communications network 1026 using a transmission medium via the network interface device 1020 using any one of a number of well-known transfer protocols (e.g., Hypertext Transfer Protocol [HTTP]). Examples of communication networks include a local area network (LAN), a wide area network (WAN), the Internet, mobile telephone networks, plain old telephone service (POTS) networks, and wireless data networks (e.g., Wi-Fi, 3G, 4G Long-Term Evolution (LTE)/LTE-A, 5G, or WiMAX networks).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Various components are described in the present disclosure as being

configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other examples can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as examples can feature a subset of said features. Further, examples can include fewer features than those disclosed in a particular example. Thus, the following claims are hereby incorporated into the Detailed Description, with each claim standing on its own as a separate example. The scope of the examples disclosed herein is to be determined with reference to the appended claims, along with the full scope of equivalents to which such claims are entitled.

1. A system for operating an autonomous vehicle, comprising:
at least one processor programmed to perform operations comprising:
receiving a plurality of job requests;
executing a matching cycle to match respective job requests of the plurality of job requests to at least one respective vehicle of a plurality of vehicles, the plurality of vehicles comprising the autonomous vehicle;
selecting a set of job requests from the plurality of job requests that were matched to the autonomous vehicle during the matching cycle, the set of job requests comprising a first job request from a first user and a second job request from a second user;
sending job request data describing the set of job requests to an autonomous vehicle computing device associated with the autonomous vehicle;
receiving verification data from the autonomous vehicle computing device, the verification data indicating that the autonomous vehicle is suitable for the set of job requests;
sending, to a first user device associated with the first user, a first offer message describing a first offer for the autonomous vehicle to execute a first job indicated by the first job request;
receiving, from the first user device, a first reply message responsive to the first offer; and
sending an instruction for the autonomous vehicle to begin executing a selected job from the set of job requests, an identity of the selected job being based at least in part on the first reply message.

2. The system of claim 1, the first reply message indicating that the first user has rejected the first offer, the operations further comprising:
after receiving the first reply message, sending, to a second user computing device associated with the second user, a second offer for the autonomous vehicle to execute a second job indicated by the second job request; and
receiving, from the second user computing device, a reply message responsive to the second offer, the reply message responsive to the second offer indicating that the second user has accepted the second offer, and the selected job being the second job.

3. The system of claim 1, the first job being the selected job, the operations further comprising, after receiving the first reply message, matching the second job request to a second vehicle different than the autonomous vehicle.

4. The system of claim 3, the first reply message indicating that the first user has accepted the first offer and the selected job being the first job, the operations further comprising, after receiving the first reply message, executing a second matching cycle to match the second job request to the second vehicle.

5. The system of claim 1, the selecting of the set of job requests comprising:
determining a portion of the plurality of job requests that were matched to the autonomous vehicle by the matching cycle;
accessing vehicle match score data for each of the portion of the plurality of job requests; and
based on the vehicle match score data, selecting at least one of the plurality of job requests for including in the set of job requests.

6. The system of claim 5, the operations further comprising:
determining that a third job request of the portion of the plurality of job requests has been considered by more than a threshold number of matching cycles;
and omitting the third job request from the set of job requests.

7. The system of claim 5, the operations further comprising:
determining that more than a threshold amount of time has elapsed since receiving a third job request of the plurality of job requests; and
omitting the third job request from the set of job requests.

8. The system of claim 5, the set of job requests comprising a predetermined number of job requests from the portion of the plurality of job requests that were matched to the autonomous vehicle.

9. The system of claim 5, the operations further comprising:
determining that a third job request of the portion of the plurality of job requests has a match score for a second vehicle of the plurality of vehicles that is more favorable than a match score between the third job request and the autonomous vehicle; and
omitting the third job request from the set of job requests.

10. The system of claim 1, the operations further comprising,
selecting a second set of job requests from the plurality of job requests that were matched to a second autonomous vehicle, the second set of job requests comprising the second job request and a third job request from a third user;
sending job request data describing the second set of job requests to a second autonomous vehicle computing device associated with the second autonomous vehicle;
receiving second verification data from the second autonomous vehicle computing device, the second verification data indicating that the second autonomous vehicle is suitable for the second set of job requests;
sending an offer message to a third user device associated with the third user, the offer message describing an offer for the second autonomous vehicle to execute a third job indicated by the third job request;
receiving, from the third user device, a reply message declining the offer for the second autonomous vehicle to execute the third job; and
after receiving the reply message from the third user device, sending, to a second user computing device associated with the second user, an offer message describing an offer for the second autonomous vehicle to execute a second job indicated by the second job request.

11. The system of claim 1, the operations further comprising, before receiving the first reply message, sending to a second user computing device associated with the second user, a second offer for the autonomous vehicle to execute a second job indicated by the second job request, the selected job being the first job.

12. The system of claim 11, the operations further comprising receiving, from the second user computing device, a second reply message responsive to the second offer, the first reply message being received before the second reply message.

13. The system of claim 1, the operations further comprising after selecting the set of job requests, determining that durable AV opt-in data has been received from the first user, the selected job being the first job.

14. A method for operating an autonomous vehicle, the method comprising:
receiving a plurality of job requests;
executing a matching cycle to match respective job requests of the plurality of job requests to at least one respective vehicle of a plurality of vehicles, the plurality of vehicles comprising the autonomous vehicle;
selecting a set of job requests from the plurality of job requests that were matched to the autonomous vehicle during the matching cycle, the set of job requests comprising a first job request from a first user and a second job request from a second user;
sending job request data describing the set of job requests to an autonomous vehicle computing device associated with the autonomous vehicle;
receiving verification data from the autonomous vehicle computing device, the verification data indicating that the autonomous vehicle is suitable for the set of job requests;
sending, to a first user device associated with the first user, a first offer message describing a first offer for the autonomous vehicle to execute a first job indicated by the first job request;
receiving, from the first user device, a first reply message responsive to the first offer; and
sending an instruction for the autonomous vehicle to begin executing a selected job from the set of job requests, an identity of the selected job being based at least in part on the first reply message.

15. The method of claim 14, the first reply message indicating that the first user has rejected the first offer, the method further comprising:
after receiving the first reply message, sending, to a second user computing device associated with the second user, a second offer for the autonomous vehicle to execute a second job indicated by the second job request; and
receiving, from the second user computing device, a reply message responsive to the second offer, the reply message responsive to the second offer indicating that the second user has accepted the second offer, and the selected job being the second job.

16. The method of claim 14, the first job being the selected job, the method further comprising, after receiving the first reply message, matching the second job request to a second vehicle different than the autonomous vehicle.

17. The method of claim 16, the first reply message indicating that the first user has accepted the first offer and the selected job being the first job, the method further comprising, after receiving the first reply message, executing a second matching cycle to match the second job request to the second vehicle.

18. The method of claim 17, the selecting of the set of job requests comprising:
determining a portion of the plurality of job requests that were matched to the autonomous vehicle by the matching cycle;
accessing vehicle match score data for each of the portion of the plurality of job requests; and
based on the vehicle match score data, selecting at least one of the plurality of job requests for including in the set of job requests.

19. The method of claim 14, further comprising, before receiving the first reply message, sending to a second user computing device associated with the second user, a second offer for the autonomous vehicle to execute a second job indicated by the second job request, the selected job being the first job.

20. A non-transitory machine-readable medium comprising instructions thereon that, when executed by at least one processor, because the at least one processor to perform operations comprising:
receiving a plurality of job requests;
executing a matching cycle to match respective job requests of the plurality of job requests to at least one respective vehicle of a plurality of vehicles, the plurality of vehicles comprising an autonomous vehicle;
selecting a set of job requests from the plurality of job requests that were matched to the autonomous vehicle during the matching cycle, the set of job requests comprising a first job request from a first user and a second job request from a second user;
sending job request data describing the set of job requests to an autonomous vehicle computing device associated with the autonomous vehicle;
receiving verification data from the autonomous vehicle computing device, the verification data indicating that the autonomous vehicle is suitable for the set of job requests;
sending, to a first user device associated with the first user, a first offer message describing a first offer for the autonomous vehicle to execute a first job indicated by the first job request;
receiving, from the first user device, a first reply message responsive to the first offer; and
sending an instruction for the autonomous vehicle to begin executing a selected job from the set of job requests, an identity of the selected job being based at least in part on the first reply message.
